(19) United States
(12) Patent Application Publication
(10) Pub. No.: US 2006/0290788 A1
(43) Pub. Date: Dec. 28, 2006

(54) Image capturing apparatus, control method and program therefor

(75) Inventors: Shuichi Ohtsuka, Kanagawa (JP); Kazuo Shiota, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD

(21) Appl. No.: 11/471,508

(22) Filed: Jun. 21, 2006

(30) Foreign Application Priority Data
Jun. 27, 2005 (JP) 2005-187028

(51) Int. Cl. H04N 5/76

(52) U.S. Cl. 348/231.3

(57) ABSTRACT

An image capturing apparatus for setting the displaying order of a plurality of captured images with easier operation is provided. The image capturing apparatus includes: an image capturing section for capturing a plurality of images; an image recording section for sequentially recording the plurality of images captured by the image capturing section; an image display section for sequentially displaying the plurality of images recorded by the image recording section; an image selecting section for selecting one image displayed by the image display section as a selected image; an image capturing instruction inputting section for inputting an image capturing instruction to capture an adding image to be added behind/in front of the selected image while the selected image is selected; and an image adding section for recording on the image recording section, the adding image captured by the image capturing section according to the image capturing instruction as an image to be display behind/in front of the selected image.

### CROSS REFERENCE TO RELATED APPLICATION

The present application relates to and claims priority from a Japanese Patent Application No. 2005-187028 filed in Japan on Jun. 27, 2005, the contents of which are incorporated herein by reference for all purpose.

### BACKGROUND OF THE INVENTION

1. Field of the Invention

The present invention relates to an image capturing apparatus, a control method, and a program therefor. Particularly, the present invention relates to an image capturing apparatus for determining a recording order or a displaying order of a plurality of captured images, and a control method and a program therefore.

2. Related Art

Conventionally, a large amount of images are generally captured and managed not only for the purpose of business but also a personal use because digital cameras and large capacity recording medium can be obtained at relatively low cost. Then, in order to effectively manage the large amount of images, various methods have been performed. For example, the images are classified into groups, the images are reordered to easily view, and the images are trimmed and turned to transform the images, and then, the images are recorded on the recording medium.

A technology for storing an image which is inputted when a digital album is opened in the digital album but storing an image which is inputted when a digital album is closed in a new digital album is proposed, for example as disclosed in Japanese Patent Application Publication No. 2000-82128. The technology can simplify to select a digital album in which images are stored so that the user's work can be reduced.

However, the above-described conventional art can not effectively determine the displaying order of a plurality of images stored in one digital album. Therefore, when the displaying order of the plurality of images in the digital album is determined, the user has to reorder the images or input any number value indicative of the order, so that it has been troublesome. Additionally, the object of the above-conventional art is to effectively manage the plurality of images have been captured. Therefore, it has been impossible to control the order relation between a newly captured image and a plurality of existing images by the same image capturing apparatus.

### SUMMARY OF THE INVENTION

Thus, it is an object of the present invention to provide an image capturing apparatus, a control method and a program therefore which are capable of solving the problem accompanying the conventional art. The above and other objects can be achieved by combining the features recited in independent claims. Then, dependent claims define further effective specific example of the present invention.

A first aspect of the present invention provides an image capturing apparatus. The image capturing apparatus includes: an image capturing section for capturing a plurality of images; an image recording section for sequentially recoding the plurality of images captured by the image capturing section; an image display section for displaying the plurality of images recorded by the image recording section; an image selecting section for selecting one image displayed by the image display section as a selected image; an image capturing instruction inputting section for inputting an image capturing instruction to capture an adding image to be displayed at a predetermined timing for the timing at which the selected image is displayed while the selected image is selected; and an image adding section for recording on the image recording section, the adding image captured by the image capturing section according to the image capturing instruction as an image to be displayed at a predetermined timing for the timing at which the selected image is displayed.

The adding section may record on the image recording section, the adding image captured by the image capturing section according to the image capturing instruction as an image to be displayed as substitute for the selected image at the timing at which the selected image is displayed. Additionally, the image adding section may record on the image recording section, the adding image captured by the image capturing section according to the image capturing instruction as an image to be displayed behind/in front of the selected image.

The image selecting section may select one image as a selected image in response to that a user instruct to select the one image while the image display section displays the one image to the user. The image display section may display an image capturing range to be captured by the image capturing section while the selected image is continuously selected. The image capturing instruction inputting section may input the image capturing instruction while the image capturing range is displayed. The image adding section may record on the image recording section, the adding image captured by the image capturing section according to the image capturing instruction as an image to be displayed at a predetermined timing for the timing at which the selected image is selected.

The image capturing apparatus may further include an album information file recording section for recording an album information file on which the displaying order a plurality of images by a display device is recorded as a file different from each of the plurality of images. The image adding section may record the adding image on the image recording section, and also record information indicating that the adding image should be displayed at a predetermined timing for the timing at which the selected image is displayed.

Additionally, the image selecting section may select two or more selected images based on the instruction by the user. The image capturing instruction input section may sequentially input image capturing instructions to capture the adding image to be displayed at a predetermined timing for the timing at which each of the selected images is displayed. The image adding section may sequentially record on the image recording section, the adding image captured by the image capturing section according to the image capturing instruction to capture the selected image as an image displayed at a predetermined timing for the timing at which the selected image is displayed. The image display section may display the next selected image in response to that the image capturing instruction inputting section inputs the image capturing instruction for a predetermined time.

The image capturing section may capture the adding image under an image capturing condition selected by the image selecting section according to the image capturing instruction.

The image capturing apparatus may further include an image capturing condition recording section for recording the image capturing condition for each of a plurality of images in association with the plurality of images recorded by the image recording section, and an image capturing condition determining section for determining the image capturing condition for the adding image based on the image capturing condition recorded by the image capturing condition recording section in association with the continuous plurality of images including the selected image. The image capturing section may capture the adding image under the condition determined by the image capturing condition determining section according to the image capturing instruction.

The image capturing condition determining section may determine the image capturing condition for the adding image based on the average value of the image capturing condition recorded by the image capturing condition recording section in association with the plurality of continuous images including the selected image.

A second aspect of the present invention provides a control method for an image capturing apparatus including an image capturing section for capturing a plurality of images, an image recording section for sequentially recording a plurality of images captured by the image capturing section and an image display section for sequentially displaying the plurality of images recorded by the image recording section. The control method includes the steps of: selecting one image displayed by the image display section as a selected image based on an instruction by a user; inputting an image capturing instruction to capture an adding image to be displayed at a predetermined timing for the timing at which the selected image is displayed; and recording on the image recording section, the adding image captured by the image capturing section according to the image capturing instruction as an image to be displayed at a predetermined timing for the timing at which the selected image is displayed.

A third aspect of the present invention provides a program for controlling an image capturing apparatus including an image capturing section for capturing a plurality of images, an image recording section for sequentially recording a plurality of images captured by the image capturing section and an image display section for sequentially displaying the plurality of images recorded by the image recording section. The program operates the image capturing apparatus to function as; an image selecting section for selecting one image displayed by the image display section as a selected image based on the instruction by a user; an image capturing instruction inputting section for inputting an image capturing instruction to capture an adding image to be displayed at a predetermined timing for the timing at which the selected image is displayed while the selected image is selected; and an image adding section for recording on the image recording section, the adding image captured by the image capturing section according to the image capturing instruction as an image to be displayed at the predetermined timing for the timing at which the selected image is displayed.

A fourth aspect of the present invention provides an image capturing apparatus. The image capturing apparatus includes an image capturing section for capturing a plurality of images; an image recording section for sequentially recording the plurality of images captured by the image capturing section; an image display section for arranging the plurality of images recorded by the image recording section in a predetermined displaying order and displaying the same; an adding position display control section for causing the image display section to display displaying order information indicative of the displaying order to display an adding image newly captured by the image capturing section based on the instruction by a user; an image capturing instruction input section for inputting an image capturing instruction to capture the adding image while the image display section displays the plurality of images and the displaying order information; and an image adding section for recording on the image recording section, the adding image captured by the image capturing section according to the image capturing instruction as an image to be displayed in the displaying order indicated by the displaying order information.

The image capturing section may continuously capture a subject. The image display section may arrange a plurality of images in a preset display order and display the same in a first display region, and also may display a monitor image obtained by continuously capturing the subject by the image capturing section on a second display region different from the first display region. The adding position display control section may display a mark indicative of the displaying order to display a mark indicative of the display order to display the adding image on the first display region as the displaying order information.

The image capturing section may continuously capture the subject. The image display section may arrange the plurality of images from the front to the rear in a preset displaying order and display the same. The adding position display control section may display a monitor image obtained by continuously capturing the subject by the image capturing section in the forefront of the plurality of images displayed by the display section.

A fifth aspect of the present invention provides a control method for an image capturing apparatus including an image capturing section for capturing a plurality of images, an image recording section for sequentially recording the plurality of images captured by the image capturing section, and an image display section for arranging the plurality of images recorded by the image recording section in a preset displaying order and displaying the same. The control method includes the steps of: causing the image display section to display displaying order information indicative of a displaying order to display an adding image newly captured by the image capturing section; inputting an image capturing instruction to capture the adding image while the image display section displays the plurality of images and the displaying order information; and recording on the image capturing section, the adding image captured by the image capturing section according to the image capturing instruction as an image to be displayed in the displaying order indicated by the displaying order information.

A sixth aspect of the present invention provides a program for controlling an image capturing apparatus including: an image capturing section for capturing a plurality of images; an image recording section for sequentially recording the plurality of images captured by the image capturing section; and an image display section for arranging the plurality of images recorded by the image recording section in a preset displaying order and displaying the same. The program operates the image capturing apparatus to function as: an image capturing section for capturing a plurality of images; an image recording section for sequentially recoding the plurality of images captured by the image capturing section; an image display section for displaying the plurality of images recorded by the image recording section; an image selecting section for selecting one image displayed by the image display section as a selected image; an image capturing instruction inputting section for inputting an image capturing instruction to capture an adding image to be displayed at a predetermined timing for the timing at which the selected image is displayed while the selected image is selected; and an image adding section for recording on the image recording section, the adding image captured by the image capturing section according to the image capturing instruction as an image to be displayed at a predetermined timing for the timing at which the selected image is displayed.

Here, all necessary features of the present invention are not listed in the summary of the invention. The sub-combinations of the features may become the invention.

According to the present invention, the displaying order of a plurality of captured images can be set with an easier operation.

### BRIEF DESCRIPTION OF THE DRAWINGS

FIG. 1 shows a whole configuration of an image management system 10;

FIG. 2 is a block diagram of the function of an image capturing apparatus 20;

FIG. 3 shows an example of a data structure of a recording medium 30;

FIG. 4 is a flowchart of a processing to select a selected image by the image selecting section 230;

FIG. 5 is a flowchart of a processing to add an adding image by the image adding section 250;

FIG. 6 shows the detailed processing flow of S520;

FIG. 7 shows an example of displaying order to display adding images in association with captured images;

FIG. 8 shows an example of a monitor screen 800 of the image capturing apparatus 20;

FIG. 9 shows another example of the monitor screen 800 of the image capturing apparatus 20;

FIG. 10 shows an example of a computer 1500 of the image capturing apparatus 20.

### DETAILED DESCRIPTION OF THE INVENTION

Hereinafter, the present invention will now be described through preferred embodiments. The embodiments do not limit the invention according to claims and all combinations of the features described in the embodiments are not necessarily essential to means for solving the problems of the invention.

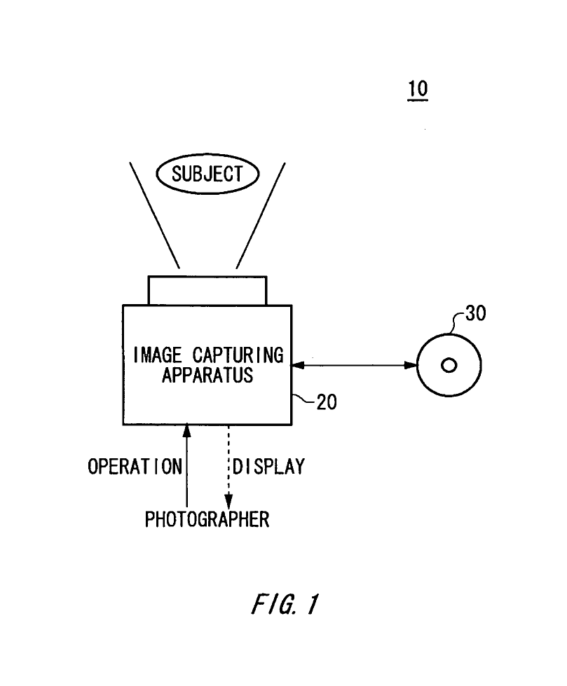

FIG. 1 shows a whole configuration of an image management system 10. The image management system 10 includes an image capturing apparatus 20 and a recording medium 30. The image capturing apparatus 20 captures a subject according to an image capturing operation by a photographer. Then, the image capturing apparatus 20 records the captured image on the recording medium 30. Additionally, the image capturing apparatus 20 displays the image recorded on the recording medium 30 to the photographer. The object of the image capturing apparatus 20 according to the present embodiment is to set the relationship of the displaying order between the image which has been captured and an image which will be captured with an easier and intuitive operation during capturing the image.

Here, the image capturing apparatus 20 may read the program from such as the recording medium 30 and execute the same. The recording medium may be not only a magneto-optical recording medium illustrated as the recording medium 30 but also may be a semiconductor recording medium such as a memory card and a magnetic recording medium such as a hard disk drive.

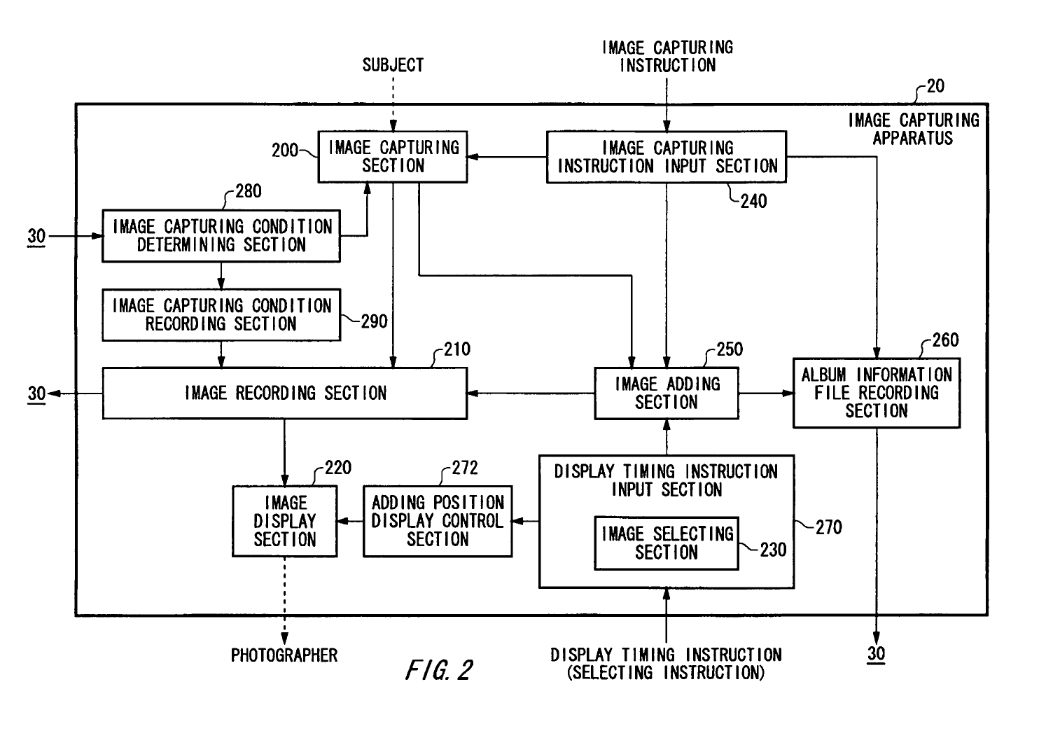

FIG. 2 is a block diagram of the function of an image capturing apparatus 20. The image capturing apparatus 20 includes an image capturing section 200, an image recording section 210, an image display section 220, a display timing instruction input section 270, an image instruction input section 240, an image adding section 250, an album information file recording section 260, an adding position display control section 272, an image capturing condition determining section 280 and an image capturing condition recording section 290. The display timing instruction input section 270 includes an image selecting section 230. The image capturing section 200 captures an image of the subject in response to that the image capturing instruction input section 240 receives an image capturing instruction to capture an image. For example, the image capturing instruction input section 240 may determine that the image capturing instruction is received when the shutter button of the image capturing apparatus 20 is pushed by the user, for example.

The image recording section 210 sequentially records the plurality of images captured by the image capturing section 200. Usually, the image recording section 210 records the plurality of images captured by the image capturing section in the order of the image-capturing. Additionally, the image recording section 210 may output image data of the images recorded therein and record the same on the recording medium 30. The image display section 220 sequentially displays the plurality of images recorded by the image recording section 210. The display timing instruction input section 270 inputs a display timing indicative of the position in the displaying order of the images displayed by the image display section 220, at which adding image newly captured should be displayed based on the instruction of the user. Specifically, the image selecting section 230 selects one image displayed by the image display section 220 based on the instruction by the user as a selected image. The image capturing instruction input section 240 inputs an image capturing instruction to capture an adding image to be displayed at a predetermined timing for the timing at which the selected image is displayed while the selected image is selected. For example, the captured instruction input section 240 inputs the image capturing instruction to capture the adding image to be added behind/in front of the selected image while the selected image is selected. Then, the image adding section 250 records on the image recording section 210, the adding image captured by the image capturing section according to the image capturing instruction as an image to be displayed behind/in front of the selected image. Here, the behind/in front of the selected image may be the immediately behind/in front of the selected image. Additionally, the image capturing instruction input section 240 may input an image capturing instruction to capture an adding image to be displayed as substitute for the selected image at the timing at which the selected image is displayed while the selected image is selected. Then, the image adding section 250 may record on the image recording section 210, the adding image captured by the image capturing section 200 according to the image capturing instruction as the image to be displayed as substitute for the selected image at the timing at which the selected image is displayed.

The album information file recording section 260 records an album information file on which the order to display a plurality of images by the display device as a file different from each of the plurality of images. The recorded album information file may be further recorded on the recording medium 30. Specifically, firstly the album information file recording section 260 creates an album information file to record the image as a group according to the instruction to create a digital album for storing images. Initially, the album information file may not include any image. Then, the album information file recording section 260 sequentially records the identification information of the image captured based on the image capturing instruction every time the image capturing instruction input section 240 inputs an image capturing instruction.

Additionally, when the image capturing section 200 captures an adding image, the image adding section 250 records the adding image on the image recording section 210 and also records information indicating that the adding image should be displayed behind/in front of the selected image on the album information file in the album information file recording section 260. For example, the album information file recording section 260 may insert the identification number of the adding image into the number arrangement in which the identification numbers of images in the album information file are arranged in the displaying order of the images.

The image capturing condition recording section 290 records the image capturing condition for each of the plurality of images in association with the plurality of images recorded by the image recording section 210. The image capturing condition determining section 280 determines the image capturing condition of the adding image based on the image capturing condition recorded by the image capturing condition recording section 290 in association with the plurality of continuous images including the selected image. For example, the image capturing condition determining section 280 determines the image capturing condition of the adding image based on the average value of the image capturing condition recorded by the image capturing condition recording section 290 in association with the plurality of continuous images. Then, the image capturing section 200 captures the adding image under the image capturing condition determined by the image capturing condition determining section 280 according to the image capturing instruction. Here, the image capturing section 200 may capture the adding image under the image capturing condition of the selected image selected by the image selecting section 230 according to the image capturing instruction.

The image display section 220 arranges the plurality of images recorded on the image recording section 210 in a preset displaying order and displays the same. Then, the adding position display control section 272 causes the image display section 220 to display displaying order information indicative of the displaying order to display an adding image newly captured by the image capturing section 200 for the plurality of images displayed by the image display section 220 based on the instruction by the user. Then, the image capturing instruction input section 240 inputs the image capturing instruction to capture the adding image while the image display section 220 displays the plurality of images and the displaying order information. Then, the image adding section 250 records on the image recording section 210, the adding image captured by the image capturing section 200 according to the image capturing instruction as an image to be displayed in the displaying order indicated by the displaying order information.

The image capturing section 200 may sequentially capture the subject. At this time, the image display section 220 arranges the plurality of images in a preset displaying order and displays the same in a first display region, and also displays a monitor image obtained by continuously capturing the subject by the image capturing section 200 to capture an adding image to be newly captured by the image capturing section 200 on a second display region different from the first display region. Then, the adding position display control section 272 displays a mark indicative of the displaying order to display the adding image on the first display region as displaying order information.

For another example, the image display section 220 may arrange a plurality of images from the front to the rear in a preset displaying order and display the same. Then, the adding position display control section 272 may cause the image display section 220 to display a monitor image obtained by continuously capturing the subject by the image capturing section 200 on the forefront of the plurality of images displayed by the display section. At this time, the adding position display control section 272 arranges a plurality of images subsequently displayed after the adding image is displayed from the front to the rear in a preset displaying order and causes the image display section 220 to display the same. Thereby the user can more intuitively recognize the order to display the adding image. Here, the image display section 220 may arrange the plurality of images from the back to the front in a preset displaying order and display the same. At this time, the adding position display control section 272 arranges the plurality of images subsequently displayed before the adding image is displayed from the back to the front in a predetermined displaying order and displays the same.

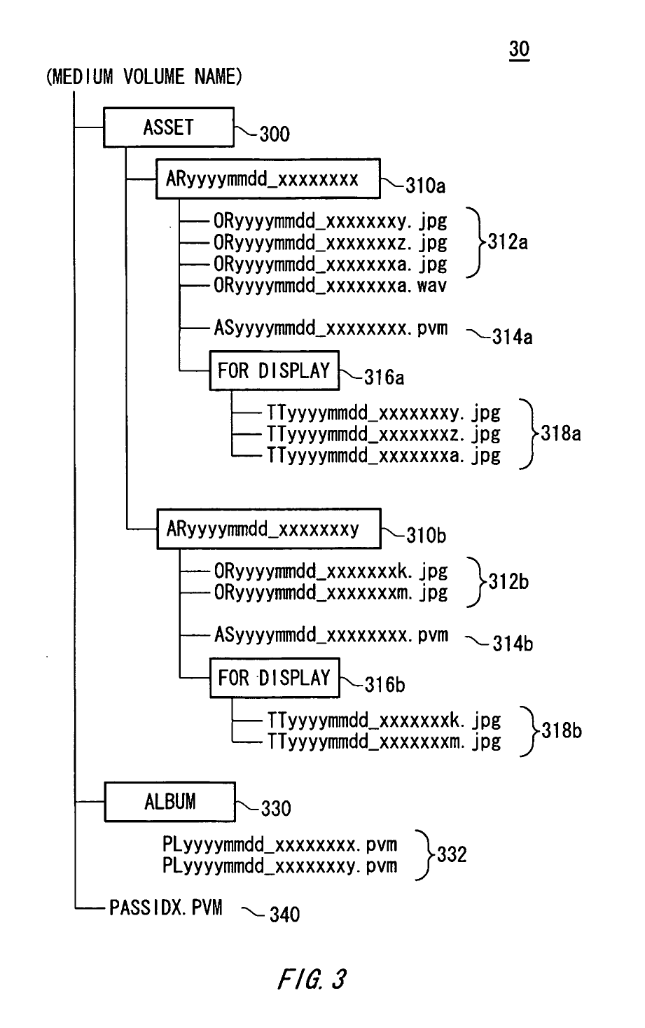

FIG. 3 shows an example of a directory configuration and a file configuration of a recording medium 30 according to the present embodiment. The recording medium 30 according to the present embodiment is based on the standard to record the plurality of captured images and the album information file on the recording medium as each individual file, respectively. The standard is called as Picture Archive And Sharing System Standard, which is a unified standard devised by a plurality of persons in the same profession including the applicant. Specifically, the recording medium 30 stores an asset directory 300, an album directory 330 and an index file 340 immediately under a root directory. The asset directory 300 stores the data of the captured image in the plurality of asset roll directories (310a and 310b, hereinafter referred to as 310). Here, the asset roll directory 300 stores two asset roll directories 310 as shown in FIG. 3. However, the asset directory 300 may store only one, or three or more asset roll directories 310.

The asset roll directory 310a stores a plurality of images 312a, an asset information file 314a and a display image directory 316a. Additionally, the asset roll directory 310a may further store a recorded sound. The plurality of images 312a may be still images and moving images captured by the image capturing apparatus 20, for example. The asset information file 314a stores a pass for each of the plurality of images 312a stored in the asset roll directory 310a. The display directory 316a is located in the low order of the asset roll directory 310a and stores a plurality of display images 318a. The plurality of display images 318a may be images displayed instead of the plurality of images 312, and may be images obtained by reducing the resolution of the plurality of images. Here, the asset roll directory 310a may store a plurality of display directories having the different resolution and aspect ratio of the display image each other. Therefore, even if the display device for displaying a display image is different, and the resolution and the aspect ratio are different for each display method, an image with a high quality, which is appropriate for the display device and the display method can be displayed. The asset information file 314a further stores a pass for each of the plurality of display images 318a.

The asset roll directory 310b stores a plurality of images 312b, an asset information file 314b and a display image directory 316b storing the plurality of display images 318b. The recording medium 30 can classify a plurality of images into the plurality of asset roll directories 310 and store the same.

The album directory 330 stores a plurality of album information files 332. The album information files 332 are provided for each group into which images are classified. Then, each of the album information files 332 defines the displaying order of the images included in the group according to the album information file among the plurality of images recorded on the recording medium 30 (312a and 312b, hereinafter referred to as 312). Specifically, the album information file 332 may store, according to the displaying order, the pass for the asset information files (314a and 314b, hereinafter referred to as 314) storing the pass for the image to be displayed, and the image identifier to identify each of the images to be displayed. In this case, the asset information file 314 may store the pass for each of the plurality of images 312 and the image identifier to identify the image in association with each other.

The index file 340 stores a pass for each of the plurality of asset information files 314 and a pass for each of the plurality of album information files 332. Here, the index file 340 is recorded on a predetermined pass which is not different for each of the recording medium 30. Specifically, the index file 340 may be recorded as a file name “PASSIDX.PVM” directly under the root directory of the recording medium 30.

Here, at least a part of the asset directory 300, the asset roll directory 310, the plurality of images 312, the asset information file 314, a display image directories (316a and 316b, hereinafter referred to as 316), the plurality of display images 318, an album directory 330 and the plurality of album information file 332 may be different each other dependent on the format of recording medium 30 which is previously determined by the user. Here, the format of the recording medium 30 may be Fujicolor (registered trademark) CD, Picture CD (registered trademark) and HotAlbum (registered trademark). Here, the asset roll directory 310 may have a directory name being capable of identifying the asset roll directory 310 for each of the plurality of recording medium 30. In the same way, at least a part of the plurality of images 312, the asset information file 314, the display image directory 316, the plurality of display images 318, the album directory 330 and the plurality of album information files 332 may have a name being capable of identifying the file and the directory included in each of the plurality of recording medium 30.

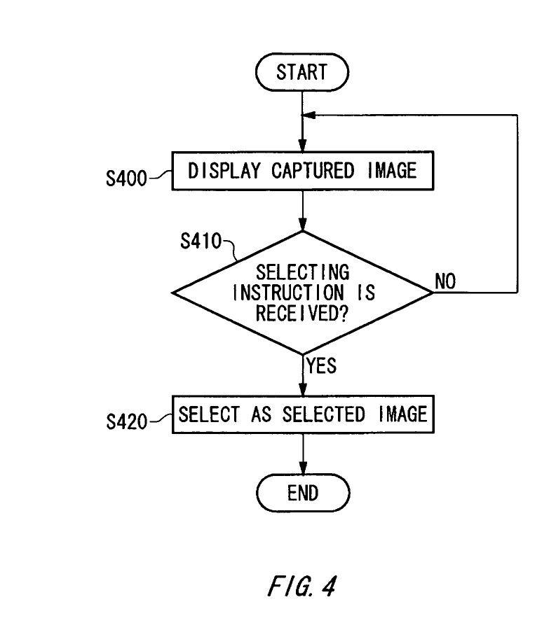

FIG. 4 is a flowchart of a processing to select a selected image by the image selecting section 230. The image capturing section 200 displays one image designated by the user among the images have been captured by the image capturing section 200 (S400). Then, the image selecting section 230 selects the image as a selected image in response to that the user instructs to select the image (S410: YES) while the image capturing section 200 displays the image to the user (S420). The image capturing apparatus 20 may repeat the above-described processing every time an image to be displayed is changed by the user. In this case, the image selecting section 230 selects two or more selected images based on the instruction by the user and records each of the selected images along with the selecting order.

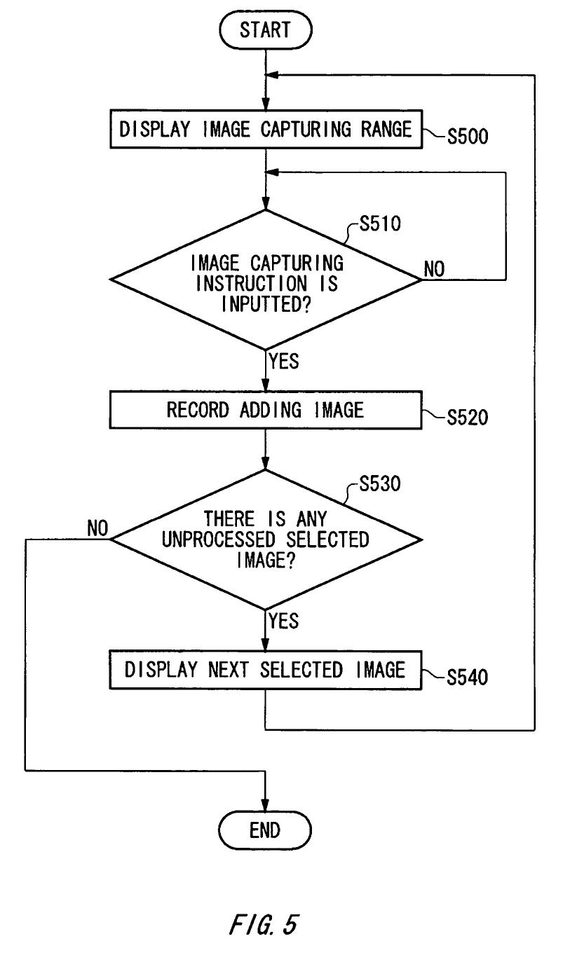

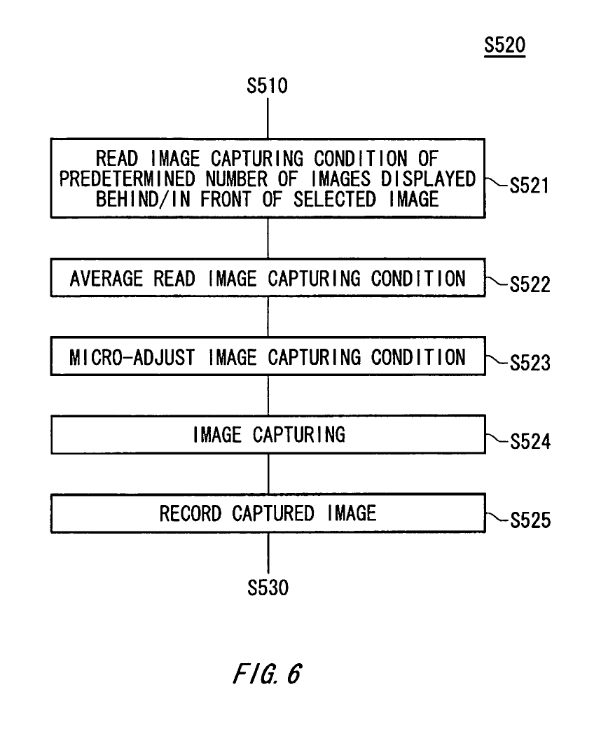

FIG. 5 is a flowchart of a processing to add an adding image by the image adding section 250. The image capturing section 200 displays an image capturing range to be captured by the image capturing section 200 while the selected image is continuously selected (S500). The image capturing instruction input section 240 inputs an image capturing instruction while the image capturing range is displayed (S510). When the image capturing instruction is inputted (S510: YES), the image adding section 250 records on the image recording section 210, the adding image captured by the image capturing section 200 according to the image capturing instruction as an image displayed behind/in front of the selected image firstly selected. (S520). Here, the detailed processing of S520 will be described with reference to FIG. 6.

When there is any selected image which has not been processed in the case that the plurality of selected images are selected (S530: YES), the image capturing section 200 displays a selected image following the selected image to be added in the S520 (S540). After the next selected image is displayed for the predetermined time, the image capturing apparatus 20 returns the process to the S500 and captures the next adding image. Meanwhile, if there is no selected image which has not been processed (S530: No), the image capturing apparatus 20 ends to capture any adding image.

FIG. 6 shows the detailed processing flow of S520. The image capturing condition determining section 280 reads the image capturing condition of the predetermined number of images including the selected image, which are displayed behind/in front of the selected image (S521). For example, the image capturing condition determining section 280 reads the image capturing condition of the predetermined number of images, which are tagged to an image 312 and recorded on the recording medium 30. The image capturing condition includes a focal distance, a diaphragm and a shutter speed, for example. Then, the image capturing condition determining section 280 averages the image capturing condition read in the S521 (S522). For example, the image capturing condition determining section 280 calculates the average value of the control value for each of the focal distance, the diaphragm and the shutter speed for the predetermined number of images of which image capturing condition has been read in the S521. Then, the image capturing condition determining section 280 sets the control value of the image capturing section 200 to each of the calculated average value. Additionally, the image capturing condition determining section 280 may accept a micro adjustment of the image capturing condition from the user (S523).

Then, the image capturing-condition determining section 280 captures an adding image according to an instruction by the user (S524). Then, the image recording section 210 records the adding image captured in the S524 to the recording medium 30 (S525). At this time, the image capturing condition recording section 290 causes the image recording section 210 to record the image capturing condition when the adding image is captured in the S524 as tag information of the image 312. The image capturing condition determining section 280 may read the image capturing condition from the recording medium 30 and determine the read image capturing condition as the image capturing condition of the adding image in the S521 and the S522. Additionally, the image capturing condition determining section 280 may determine the image capturing condition of the image captured most newly among the predetermined number of images including the selected image, which are displayed behind/in front of the selected image as the image capturing condition of the adding image.

According to the above-described processing, the image capturing apparatus 20 can capture an adding image under the condition similar to the image capturing condition of the images continuously displayed at the timing close to that of the adding image. As for images to be continuously displayed, the image capturing situations are mostly similar. Therefore, it is mostly preferred that they are captured under the similar image capturing condition. The image capturing apparatus 20 can quickly and appropriately determine the image capturing condition of the adding image based on the image capturing condition of the image which has been recorded.

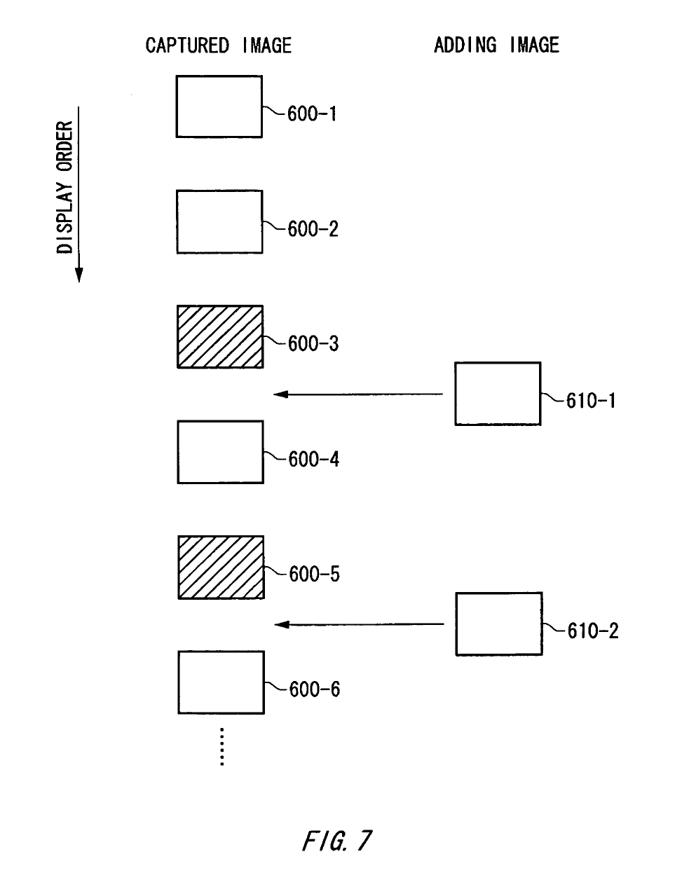

FIG. 7 shows an example of displaying order to display the adding image in association with the images which have been captured. Images 600-1-600-6 are captured by the image capturing section 200 in the order as shown in FIG. 7, so that the image display section 220 displays each of the images 600-1-600-6 in the order as shown in FIG. 7. In this case, the identification information for each of the images 600-1-600-6 is recorded in the album information file 332 of the recording medium 30 in the above-described order. Conventionally, if any other image is inserted into the images 600-1-600-6 to change the displaying order, it has been necessary to reorder the displaying order of the images by some image editing device after an image is newly captured.

Meanwhile, when the image capturing apparatus 20 according to the present embodiment adds an image and inserts the same, the user firstly designates an image to be displayed in front of the image intended to be inserted as a designated image. For example, the image selecting section 230 selects the image 600-3 as the selected image based on the designation by the user for example in FIG. 7. Here, a plurality of selected images are available. For example, the image selecting section 230 selects the image 600-5 as the next selected image in FIG. 7. The image selecting section 230 may select the further next selected image according to the designation by the user.

Next, the image capturing instruction input section 240 sequentially inputs the image capturing instruction to capture the adding image to be added behind each of the selected images while the two or more selected images are selected. For example, the image capturing section 200 captures the adding image 610-1 in response to that the image capturing instruction input section 240 inputs the initial image capturing instruction. Then, the image capturing section 200 captures the adding image 610-2 in response to that the image capturing instruction input section 240 inputs the next image capturing instruction 610-2.

The image adding section 250 records the adding image captured by the image capturing section 200 according to the image capturing instruction for each of two or more selected images as the image displayed behind the selected image. That is to say, the image adding section 250 records on the image recording section 210, the adding image 610-1 captured according to the image capturing instruction on the image 600-3 as the image displayed behind the image 600-3. Further, the image adding section 250 records on the image recording section 210, the adding image 610-2 captured according to the image capturing instruction on the image 600-5 as the image displayed behind the image 600-5. Therefore, the displaying order of the images is the image 600-1, the image 600-2, the image 600-3, the image 600-1, the image 600-4, the image 600-5, the image 600-2 and the image 600-6.

At this time, identification information of those images is recorded on the album information file 332 according to the displaying order. Specifically, the album information file recording section 260 deletes the album information file 332 on which the original displaying order of the images is recorded. The identification information of the image 600-1-600-6 have been recorded in the album information file 332. Then, the album information file recording section 260 creates an order arrangement into which the identification information on the adding image 610-1 and the adding image 610-2 are inserted and records the same on the recording medium 30 as a new album information file 332. The album information file 332 stores the identification information for each of the image 600-1, the image 600-2, the image 600-3, the adding image 610-1, the image 600-4, the image 600-5, the adding image 610-2 and the image 600-6 in the described order. Thereby the image displaying order after editing can be correctly transmitted to another device to read the recording medium 30. Further, the album information file 332 and the image data are managed as separate files, so that the amount of data to be updated by changing the displaying order can be reduced.

It has been described that each of the image 610-1- and the -image 610-2 are inserted behind the image 600-3 and the 600-5 being the selected images with reference to FIG. 7. Additionally, the image adding section 250 may cause the album information recording section 260 to record the album information file 332 in order to display the images 610-1 and 610-2 being the adding images, respectively instead of the images 600-3 and 600-5 being the selected images. In this case, the images is displayed as following order; the image 6001, the image 600-2, the adding image 610-1, the image 600-4, the adding image 610-2 and the image 600-6.

Here, the image capturing condition determining section 280 reads the image capturing condition for the predetermined number of images displayed at the timing before/after the adding image is displayed. For example, the image capturing condition determining section 280 may read the image capturing condition for the image 600-3 and the image 600-4 from the recording medium 30 in order to determine the image capturing condition to capture the image 610-1, and also may read the image capturing condition for the image 600-5 and the image 600-6 from the reading medium 30 in order to determine the image capturing condition to capture the image 610-2. Here, the image capturing condition determining section 280 may read only the image capturing condition for the image 600-3 and the 600-5 being the selected images from the recording medium 30. The image capturing apparatus 20 can easily identify the displaying order of the images by reading the album information file 332. Therefore, the image capturing condition recorded as the tag information of the image can be quickly read without reading the tag information of all images.

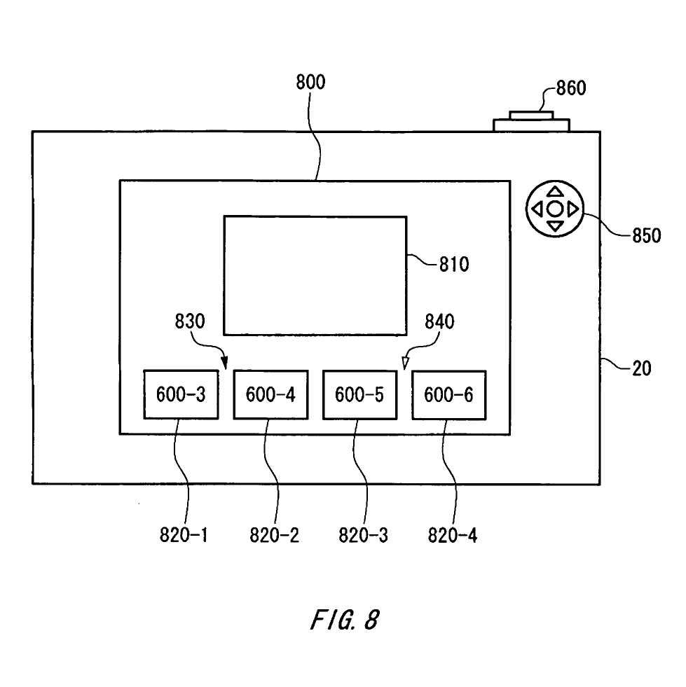

FIG. 8 shows an example of a monitor screen 800 displayed by the image display section 220. The image capturing apparatus 20 includes a release button 860, the operation button 850 and a monitor screen 800. The image display section 220 displays the plurality of images 600-3, 600-4, 600-5 and 600-6 recorded by the image recording section 210 on an image display regions 820-1, 820-2, 820-3 and 8204 (hereinafter referred to as 820) from left to light in the displaying order recorded on the album information file recording section 260. Then, the display timing instruction input section 270 moves a mark 840 indicative of the displaying order including the adding image in response to the operation button 850 by the user.

For example, when the display timing instruction input section 270 detects that the operation button 850 is operated to move to the right direction, the adding position display control section 272 moves the mark 840 indicative of the displaying order currently selected to the right direction. Then, when the display timing instruction input section 270 detects that the operation button 850 is operated to fix a timing at which the adding image is added, the adding position display control section 272 determines that the adding image is added to the position indicated by the mark. It is fixed that the adding image is inserted between the image 600-3 and the image 600-4 as shown in FIG. 7. The adding position display control section 272 may cause the image display section 220 to display a mark 830 indicative of the fixed displaying order with a design different from that of a mark 840 indicative of the displaying order currently selected.

The monitor image obtained by continuously capturing the subject by the image capturing section 200 is continuously displayed in the image display region 810 different from the image display region 820 in terms of time. The user executes various image capturing operations such as setting the image capturing instruction and setting the image capturing range as viewing the image displayed in the image display region 810. The image capturing instruction input section 240 detects that the user pushes a release button 860, the image capturing instruction input section 240 causes the image capturing section 200 to capture the subject in order to capture the adding image. Thus, the image capturing apparatus 20 can cause the user to intuitively designate the displaying order of the adding image using the marker 840.

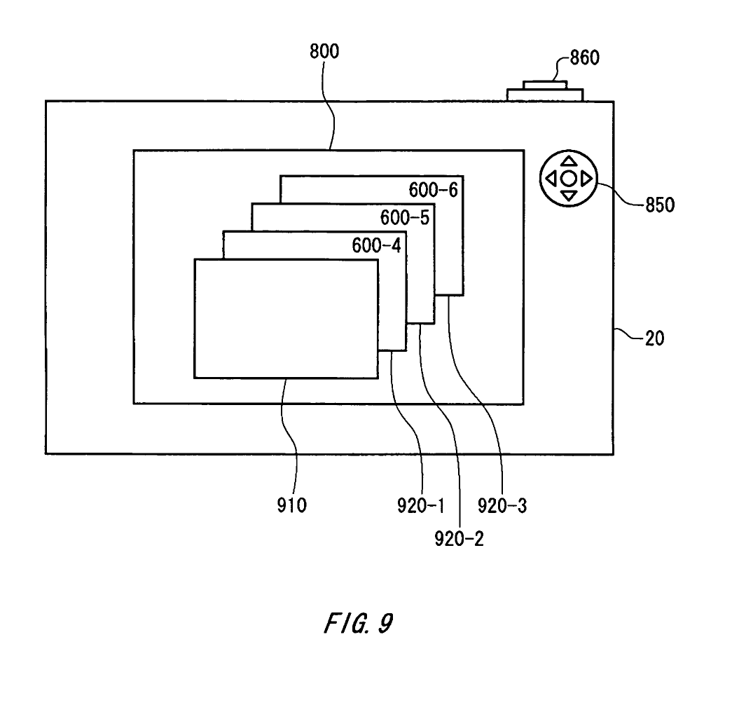

FIG. 9 shows another example of a monitor screen 800 of the image display section 220. The image display section 220 displays images 600-4, 600-5 and 600-6 on image display regions 920-1, 920-2 and 920-3 in a monitor screen 800 from the front to the rear in the displaying order recorded on the album information file recording section 260. At this time, the image display section 220 displays the images 6004, 600-5 and 600-6 which are partially overlapped each other. Then, the adding position display control section 272 displays the monitor image in an image display region 910 in front of the forefront image among the plurality of images 600-4, 600-5 and 600-6 recorded by the image recording section 210, that is to say, the image 600-4 displayed at earliest timing among the images. Therefore, the user can intuitively understand based on the monitor screen 800 that the images are recorded in order to display in the following order as; the adding image, the image 600-4, the image 600-5 and the image 600-6.

As described above, the image capturing apparatus 20 according to the present embodiment can change the order to display the image additionally captured in association with the image which has been captured with a simple operation. Thereby the image capturing apparatus 20 according to the present embodiment can appropriately edit the images before the memory at image capturing is receded in comparison with the conventional method using the image editing apparatus. Specifically, the convenience of the user can be improved in the various situation, such as an athletic festival, an entrance ceremony, a graduation ceremony or a lecture. For example, in the case that snapshots are captured in such event, it finds later to forget to take the picture of the sign plate indicative of the title of the event. In such a case, if the picture of the sign plate is taken on the way back, the picture is displayed at the end in spite of the picture characteristic of the event. However, if the displaying order of the image can be reordered by the operation of the image capturing apparatus, the images can be appropriately reordered before the memory of the event is receded.

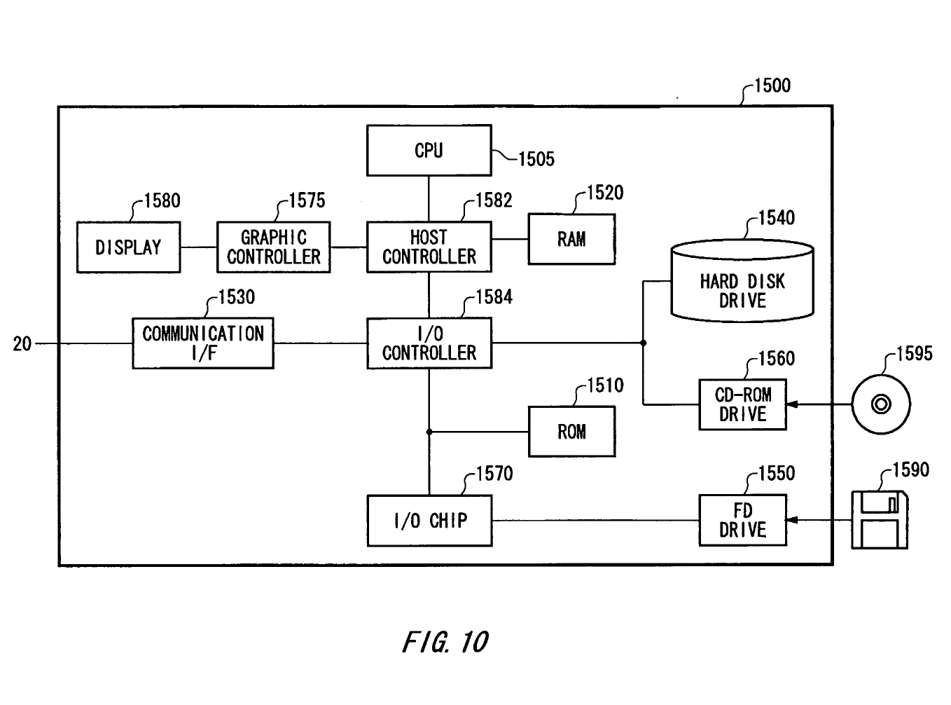

FIG. 10 shows an example of the hardware configuration of a computer 1500 of the image capturing apparatus 20 according to the present embodiment. The computer 1500 includes a CPU periphery having a CPU 1505, a RAM 1520, a graphic controller 1575 and a display 1580 which are connected through a host controller 1582 each other, an input/output unit having a communication interface 1530, a hard disk drive 1540 and a CD-ROM drive 1560 which are connected to the host controller 1582 through an input/output controller 1584 and a legacy input/output unit having a ROM 1510, a flexible disk drive 1550 and an input/output chip 1570 which are connected to the input/output controller 1584.

The host controller 1582 connects the RAM 1520 to the CPU 1505 and the graphic controller 1575 which access the RAM 1520 with a high transfer rate. The CPU 1505 operates according to the programs stored in the ROM 1510 and the RAM 1520 to control each unit. The graphic controller 1575 obtains image data generated on a frame buffer provided in the RAM 1520 by the CPU 1505 and displays the same on the display 1580. Alternatively, the graphic controller 1575 may include therein a frame buffer for storing image data generated by the CPU 1505.

The input/output controller 1584 connects the host controller 1582 to the hard disk drive 1540, the communication interface 1530 and the CD-ROM drive 1560 which are relatively high-speed input/output units. The hard disk drive 1540 stores the program and data used by the CPU 1505 in the computer 1500. The communication interface 1530 is communicated with the image capturing apparatus 20 through the network to provide the program or data to the image capturing apparatus 20. The CD-ROM drive 1560 reads the program or data from the CD-ROM 1595 and provides the same to the hard disk drive 1540 and the communication interface 1530 through the RAM 1520.

The ROM 1510, and the flexible disk drive 1550 and input/output chip 1570 which are relatively low-speed input/output units are connected to the input/output controller 1584. The ROM 1510 stores a boot program executed by the computer 1500 at activating and a program depending on the hardware of the computer 1500. The flexible disk drive 1550 reads the program or data from a flexible disk 1590 and provides the same to the hard disk drive 1540 and the communication interface 1530 through the RAM 1520. The input/output chip 1570 connects various input/output units through the flexible disk drive 1550 and such as a parallel port, a serial port, a keyboard port and a mouse port.

The program provided to the communication interface 1530 through the RAM 1520 is stored in a recording medium, such as the flexible disk 1590, the CD-ROM 1595, or an IC card and provided by the user. The program is read from the recording medium, provided to the communication interface 1530 and transmitted to the image capturing apparatus 20 through the network. The program transmitted to the image capturing apparatus 20 is installed in the image capturing apparatus 20 and executed therein.

The program installed in and executed in the image capturing apparatus 20 operates the image capturing apparatus 20 to function as the image capturing section 200, the image recording section 210, the image display section 220, the display timing instruction input section 270, the image capturing instruction input section 240, the image adding section 250, the album information file recording section 260, the adding position display control section 272, the image capturing condition determining section 280 and the image capturing condition recording section 290 which are described with reference to FIGS. 1-9. Additionally, the program operates the display timing instruction input section 270 to function as the image selecting section 230 described with reference to FIG. 1-FIG. 9.

The above-described programs may be stored in an external storage medium. The recording medium may be, in addition to the flexible disk 1590 and the CD-ROM 1595, an optical storage medium such as a DVD and a PD, a magneto-optical recording medium such as a MD, a tape medium and a semiconductor memory such as an IC card. Additionally, a storage medium such as a hard disk or a RAM which is provided in the server system connected to a private communication network or Internet is used as the recording medium to provide the program to the computer 1500 through the network.

While the present invention have been described with the embodiment, the technical scope of the invention not limited to the above described embodiment. It is apparent to persons skilled in the art that various alternations and improvements can be added to the above-described embodiment. It is apparent from the scope of the claims that the embodiment added such alternation or improvements can be included in the technical scope of the invention.

What is claimed is:

1. An image capturing apparatus comprising:
an image capturing section for capturing a plurality of images;
an image recording section for sequentially recording the plurality of images captured by the image capturing section;
an image display section for displaying the plurality of images recorded by the image recording section;
an image selecting section for selecting one image displayed by the image display section as a selected image based on an instruction by a user;
an image capturing instruction input section for inputting the image capturing instruction to capture an adding image to be displayed at a predetermined timing for the timing at which the selected image is displayed while the selected image is selected; and
an image adding section for recording on the image recording section, the adding image captured by the image capturing section according to the image capturing instruction as an image to be displayed at a predetermined timing for the timing at which the selected image is displayed.

2. The image capturing apparatus according to claim 1, wherein the image adding section records on the image recording section, the adding image captured by the image capturing section according to the image capturing instruction as the image displayed as substitute for the selected image at the timing at which the selected image is displayed.

3. The image capturing apparatus according to claim 1, wherein the image adding section records on the image recording section, the adding image captured by the image capturing section according to the image capturing instruction as an image to be displayed behind/in front of the selected image.

4. The image capturing apparatus according to claim 1, wherein
the image selecting section selects the image as the selected image in response to that a user instructs to select the image while the image display section displays one image to the user.
the image display section displays an image capturing range to be captured by the image capturing section while the selected image is continuously selected;
the image capturing instruction input section inputs the image capturing instruction while the image capturing range is displayed; and
the image adding section records on the image recording section, the adding image captured by the image capturing section according to the image capturing instruction as an image to be displayed at a predetermined timing for the timing at which the selected image is displayed.

5. The image capturing apparatus according to claim 1 further comprises an album information file recording section for recording an album information file on which the order to display the plurality of images is recorded on the display device as a file separate from each of the plurality of images, wherein
the image adding section records the adding image on the image recording section and also records information-indicating that the adding image should be displayed at the predetermined timing for the timing at which the selected image is displayed on the album information file.

6. The image capturing apparatus according to claim 1, wherein
the image selecting section selects two or more selected images based on the instruction by the user,
the image capturing instruction input section sequentially inputs the image capturing instruction to capture the adding image to be displayed at a predetermined timing for the timing at which the selected image is displayed while the two or more selected images are selected,
the image adding section sequentially records on the image recording section, the adding image captured by the image capturing section according to the image capturing instruction on the two or more selected images as the image to be displayed at the predetermined timing for the timing at which the selected image is displayed.

7. The image capturing apparatus according to claim 6, wherein the image display section displays the next selected image for a predetermined time in response to that the image capturing instruction input section inputs the image capturing instruction.

8. The image capturing apparatus according to claim 1, wherein
the image capturing section captures the adding image under the image capturing condition for the selected image selected by the image selecting section according to the image capturing instruction.

9. The image capturing apparatus according to claim 1 further comprising:
an image capturing condition recording section for recording the image capturing condition for each of the plurality of images in association with the plurality of images recorded by the image recording section; and
an image capturing condition determining section for determining the image capturing condition of the adding image based on the image capturing condition recorded by the image capturing condition recording section in association with the plurality of continuous images including the selected image, wherein
the image capturing section captures the adding image under the image capturing condition determined by the image capturing condition determining section according to the image capturing instruction.

10. The image capturing apparatus according to claim 9, wherein the image capturing condition determining section determines the image capturing condition for the adding image based on the average value of the image capturing condition recorded by the image capturing condition recording section in association with the plurality of continuous images including the selected image.

11. An control method for an image capturing apparatus including an image capturing section for capturing a plurality of images, an image recording section for sequentially recording the plurality of images captured by the image capturing section and an image display section for displaying the plurality of images recorded by the image recording section, the control method comprising:
selecting one image displayed by the image display section based on an instruction by a user;
inputting an image capturing instruction for capturing an adding image to be displayed at a predetermined timing for the timing at which the selected image is displayed while the selected image is selected; and
recording on the image recording section, the adding image captured by the image capturing section according to the image capturing instruction as an image to be displayed at a predetermined timing for the timing at which the selected image is displayed.

12. A program for controlling an image capturing apparatus including an image capturing section for capturing a plurality of image, an image recording section for sequentially recording the plurality of images captured by the image capturing section and an image display section for displaying the plurality of images recorded by the image recording section, the program operates the image capturing apparatus to function as:
an image capturing section for capturing a plurality of images;
an image recording section for sequentially recording the plurality of images captured by the image capturing section;
an image display section for displaying the plurality of images recorded by the image recording section;
an image selecting section for selecting one image displayed by the image display section as a selected image based on an instruction by a user;
an image capturing instruction input section for inputting the image capturing instruction to capture an adding image to be displayed at a predetermined timing for the timing at which the selected image is displayed while the selected image is selected; and
an image adding section for recording on the image recording section, the adding image captured by the image capturing section according to the image capturing instruction as an image to be displayed at a predetermined timing for the timing at which the selected image is displayed.

13. An image capturing apparatus comprising:
an image capturing section for capturing a plurality of images;
an image recording section for sequentially recording the plurality of images captured by the image capturing section;
an image display section for arranging the plurality of images recorded by the image recording section in a predetermined displaying order and displaying the same;
an adding position display control section for causing the image display section to display displaying order information indicative of the displaying order to display an adding image newly captured by the image capturing section for the plurality of images displayed by the image display section based on the instruction by a user;
an image capturing instruction input section for inputting the image capturing instruction to capture the adding image while the image display section displays the plurality of images and the displaying order information; and
an image adding section for recording on the image recording section, the adding image captured by the image capturing section according to the image capturing instruction as an image to be displayed in the displaying order indicated by the displaying order information.

14. The image capturing apparatus according to claim 13, wherein
the image capturing section sequentially captures a subject;
the image display section displays the plurality of images arranged in a predetermined displaying order and displays the same in a first display range, and also displays a monitor image obtained by sequentially capturing the subject by the image capturing section to capture an adding image to be newly captured by the image capturing section in a second display region different from the first display range; and
the adding position display control section displays a mark indicative of the displaying order to display the adding image as the displaying order information in the first display range.

15. The image capturing apparatus according to claim 13, wherein
the image capturing section sequentially capture the subject,
the image display section arranges the plurality of images from the front to the rear in a predetermined displaying order; and
the adding position display control section displays the monitor image obtained by sequentially capturing the subject by the image capturing section in the forefront of the plurality of images displayed by the display section.

16. A control method for an image capturing apparatus including an image capturing section for capturing a plurality of images, an image recording section for sequentially recording the plurality of images captured by the image capturing section and image display section for arranging the plurality of images recorded by the image recording section in a predetermined displaying order and displaying the same, the control method comprising:
causing the image display section to display displaying order information indicative of the displaying order to display an adding image newly captured by the image capturing section for the plurality of images displayed by the image display section based on the instruction of the user;
inputting an image capturing instruction to capture the adding image while the image display section displays the plurality of images and the displaying order information; and
recording on the image recording section, the adding image captured by the image capturing section according to the image capturing instruction as an image to be displayed in the displaying order indicated by the displaying order information.

17. A program for controlling the image capturing apparatus including an image capturing section for capturing a plurality of images, an image recording section for sequentially recording the plurality of images captured by the image capturing section and an image display section for arranging the plurality of images recorded by the image recording section in a predetermined displaying order and displaying the same, the program operates the image capturing apparatus to function as:
an image capturing section for capturing a plurality of images;
an image recording section for sequentially recording the plurality of images captured by the image capturing section;
an image display section for arranging the plurality of images recorded by the image recording section in a predetermined displaying order and displaying the same;
an adding position display control section for causing the image display section to display displaying order information indicative of the displaying order to display an adding image newly captured by the image capturing section for the plurality of images displayed by the image display section based on the instruction by a user;
an image capturing instruction input section for inputting the image capturing instruction to capture the adding image while the image display section displays the plurality of images and the displaying order information; and
an image adding section for recording on the image recording section, the adding image captured by the image capturing section according to the image capturing instruction as an image to be displayed in the displaying order indicated by the displaying order information.
